(19) United States
(12) Patent Application Publication
(10) Pub. No.: US 2020/0005207 A1
(43) Pub. Date: Jan. 2, 2020

(54) BLOCKCHAIN TRACKING OF ORGANIZATIONAL TIME FOR COST ANALYSIS AND SCHEDULING

(71) Applicant: Microsoft Technology Licensing, LLC, Redmond, WA (US)

(72) Inventors: Charles Yin-Che Lee, Mercer Island, WA (US); Ben Cheung, Redmond, WA (US); Pamela Bhattacharya, Redmond, WA (US); Juliana Pena Ocampo, Redmond, WA (US); Chala Fekadu Fufa, Seattle, WA (US); Mayerber Loureiro De Carvalho Neto, Kirkland, WA (US); Warren David Johnson, III, Sammamish, WA (US)

(21) Appl. No.: 16/023,395

(22) Filed: Jun. 29, 2018

(51) Int. Cl. G06Q 10/06; H04L 9/32

(52) U.S. Cl. CPC G06Q 10/06312; G06Q 10/063116; H04L 2209/38; H04L 9/3236; G06Q 10/06314

(57) ABSTRACT

In non-limiting examples of the present disclosure, systems, methods and devices for indicating time-cost allocation for an organization for a specified time period are presented. A virtual time coin system may be utilized to track temporal transactions made by organizational entities (e.g., organizational groups, organizational employees). A time coin application may track temporal transactions (e.g., meeting invites, meeting cancelations, meeting expansions) made by organizational entities, and those transactions may be stored on blocks of a temporal blockchain that is duplicated across a plurality of nodes in a distributed ledger. Each temporal transaction may be associated with a withdrawal or deposit of time coins from a time coin repository corresponding to the organizational entity or entities that were party to a transaction. The time coin application may analyze bocks in temporal blockchains and cause the results of that analysis to be graphically displayed.

### BACKGROUND

Meetings are generally considered a crucial task that must occur in order for companies to run their operations successfully. However, it is difficult for scheduling personnel (e.g., executives, managers, executive assistants) to identify time slots for meetings that do not largely affect attendee employees' other tasks in a negative manner That is, it is difficult for scheduling personnel to prospectively identify time slots that will have a lower attendee employee work cost to the company if booked than time slots that have a higher attendee employee work cost to the company.

It is with respect to this general technical environment that aspects of the present technology disclosed herein have been contemplated. Furthermore, although a general environment has been discussed, it should be understood that the examples described herein should not be limited to the general environment identified in the background.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter. Additional aspects, features, and/or advantages of examples will be set forth in part in the description which follows and, in part, will be apparent from the description or may be learned by practice of the disclosure.

Non-limiting examples of the present disclosure describe systems, methods and devices for indicating time-cost allocation for an organization for a specified time period. The specified time period may be a timespan in the past or a timespan in the future. A time coin application that tracks how work time is spent through the generation and analysis of temporal blockchains may be utilized to schedule meetings in least costly timespans from a time-cost perspective. The time coin application may also be utilized to generate graphical summaries of time-cost allocation in the form of time coin ratio graphics. Time coin ratio graphical summaries can be generated for entire organizations, organizational groups, organizational sub-groups, and/or organizational individuals.

### BRIEF DESCRIPTION OF THE DRAWINGS

Non-limiting and non-exhaustive examples are described with reference to the following figures:

FIG. 1 is a schematic diagram illustrating an example distributed computing environment for generating a user interface that is indicative of the employee work cost of booking a meeting at a specified time utilizing a blockchain ledger.

FIG. 2 illustrates an exemplary temporal blockchain, individual components of an exemplary block in the temporal blockchain, and the interplay of an organization time coin repository with each illustrated exemplary block.

FIG. 3 illustrates an exemplary graph that indicates work time cost to an organization for scheduling a meeting at a specified time that is generated based on analysis of a temporal blockchain ledger.

FIG. 4 illustrates a first exemplary graph that indicates work time cost to an organization for scheduling a meeting at a first specified time, and the modification of that graph that indicates work time cost to the organization for scheduling the meeting at a second specified time, both graphs generated based on analysis of a temporal blockchain ledger.

FIG. 5 is an exemplary method for indicating time-cost allocation for an organization for a specified time period.

FIGS. 6 and 7 are simplified diagrams of a mobile computing device with which aspects of the disclosure may be practiced.

FIG. 8 is a block diagram illustrating example physical components of a computing device with which aspects of the disclosure may be practiced.

FIG. 9 is a simplified block diagram of a distributed computing system in which aspects of the present disclosure may be practiced.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The various embodiments and examples described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the claims.

Examples of the disclosure provide systems, methods, and devices for indicating time-cost allocation for an organization for a specified time period. A time coin application may be utilized to track temporal transactions for organizational entities and construct temporal blockchains comprising blocks of temporal transactions. Temporal transactions and associated meeting events may be tracked in the temporal blockchains, and stored in a distributed ledger of temporal events. In some examples, other work activities (e.g., email time, phone time, document preparation time) may also be tracked in temporal blockchains and stored in a distributed ledger of temporal events. The time coin application may manage a virtual time coin repository comprising a plurality of time coins reflective of a total amount of work time available to an organization for a specified timespan. When a temporal transaction occurs, the time coin application may associate a deposit or withdrawal of time coins from the time coin repository with the transaction's block in a corresponding temporal blockchain. Utilizing user inputs to identify least costly timespans for scheduling new meetings, and/or inputs specifying one or more timespans that users would like to view time coin allocation for, the time coin application may generate graphs that summarize that information based on analysis of corresponding temporal blockchains.

According to some examples, the cost of withdrawing a time coin from an organization's time coin repository may increase as the supply of time coins in the repository goes down. As such, when a user utilizes a meeting application associated with the time coin application to book a meeting for a time period in which the time coin repository is relatively depleted (e.g., the calendars for employees in a corresponding organization have a high percentage of available time booked), the cost of booking the meeting may be higher than when the user attempts to book a meeting for a time period in which the time coin repository is relatively full (e.g., the calendars for employees in a corresponding organization have a low percentage of available time booked). In some examples, additional time may be minted for a time coin repository, thus making the cost of withdrawing time coins from the time coin repository less costly. The minting of time coins may comprise the hiring of additional employees that are expected to work during a specified time period and/or adding work hours that current employees are expected to work for the specified time period. In some examples, the time coin application may track the cost of time coins for specified time periods (e.g., specified days of the week, specified hours in a day, specified times of year), and provide analytics regarding one or more causes for the cost of withdrawing additional time coins during the specified time periods increasing or decreasing. Thus, in some examples the time coin application may provide analytics that provide an indication of what drives surges in time coin withdrawal costs for specified time periods.

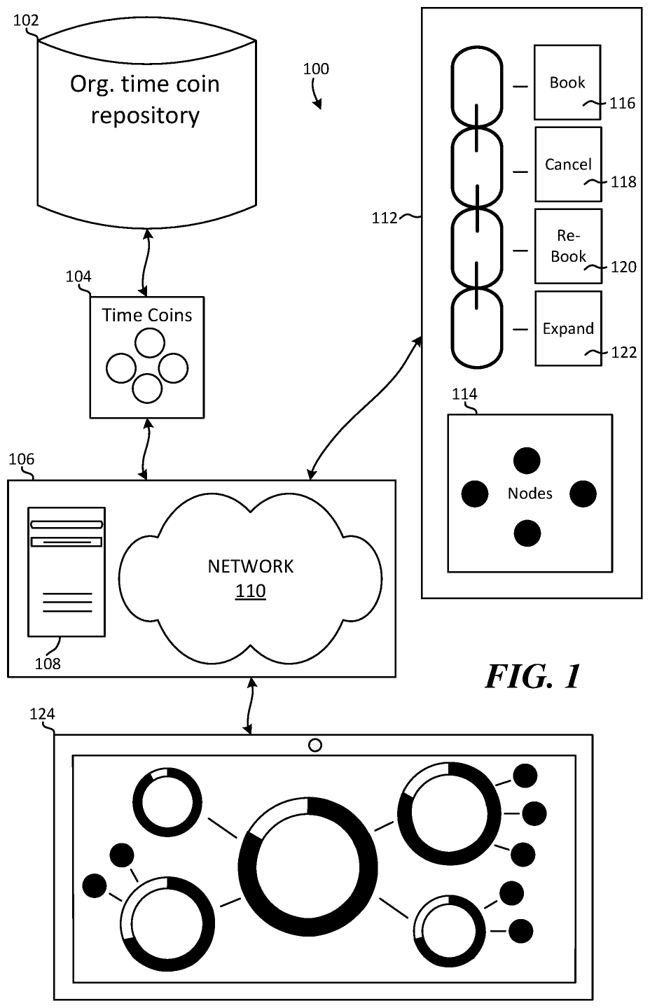

FIG. 1 is a schematic diagram illustrating an example distributed computing environment 100 for generating a user interface that is indicative of the employee work cost of booking a meeting at a specified time utilizing a blockchain ledger. Distributed computing environment 100 includes organization time coin repository 102, network and processing sub-environment 106, temporal blockchain sub-environment 112, computing device 124, and time coins 104. Time coins 104 may be withdrawn from time coin repository 102 for use in association with one or more transactions incorporated in temporal blockchain sub-environment 112, and time coins 104 may be withdrawn from one or more blocks associated with one or more transactions in blockchain sub-environment 112 and deposited back into time coin repository 102. Any of the sub-environments and/or their respective computing devices displayed in distributed computing environment 100 may communicate with one another via network 110.

Organization time coin repository 102 is a virtual repository that keeps an inventory of virtual time coins for an organization, with each time coin corresponding to a unit of employee work time for the organization. The unit of employee work time that each time coin corresponds to may comprise any set value of time, such as one second of work time for a single employee, one minute of work time for a single employee, and/or one hour of work time for a single employee, etc. Time coin repository 102 includes, for any specified timespan, a number of time coins corresponding to a total number of units of employee work time for that given timespan for the entire organization, minus a number of units of employee work time that have been expended or that are indicated as to be expended for the given timespan.

In some examples, the value of time coins may increase as the number of time coins in the time coin repository decreases. Thus, in some examples, the price per time coin may increase proportionally as the supply in the time coin repository decreases. In other examples, an administrator or manager associated with an organization may configure the value to apply to time coins based on supply or demand. Thus, when time coins left in the time coin repository for a specified duration of time are low, the expense of withdrawing additional time coins during that specified duration may be cost prohibitive.

Thus in one illustrative example, if no time coins are designated as to be expended for an organization for a specified week in the future (i.e., there are no meetings currently scheduled for that week, there are no other work tasks currently scheduled for that week), the time coin repository for that organization would include a time coin for each unit of employee work time available to the organization at that time. That is, if there are one-hundred employees in the organization, with each employee scheduled to work forty hours during the specified week, and the units of employee work time are set at one hour, the number of time coins in the time coin repository for that specified week would be 4,000 coins (i.e., 100 employees*40 units of employee work time [hours] in the specified week). Similarly, if there are one-hundred employees in the organization, with each employee scheduled to work 40 hours during the specified week, and the units of employee work time are set at one minute, the number of time coins in the time coin repository for that specified week would be 240,000 coins (i.e., 100 employees*2400 units of employee work time [minutes] in the specified week).

In another illustrative example if, for a specified week, half of the organization's one-hundred employees are scheduled in meetings for five hours per employee, there are no other tasks for that specified week that are currently scheduled, and the units of employee work time are set at one hour, the number of time coins in the time coin repository for that specified week would be 3500 coins (i.e., 100 employees*40 units of employee work time [hours] in the specified week − (minus) 100 employees*5 units of employee work time [hours] that are currently booked for meetings for the specified week). Similarly, if a user would like to see the contents of the time coin repository 102 for a specified day in the future, there are fifty employees in the organization that work on that day, with each of the fifty employees working seven hours on that day, the units of employee work time set at one minute, half of the organization's fifty employees being scheduled in meetings on the specified day for one hour per employee with no other tasks for the specified day currently scheduled, the number of time coins in the time coin repository would be 18,000 coins (i.e., 50 employees*420 units of employee work time [minutes] in the specified day − (minus) 50 employees*60 units of employee work time [minutes] that are currently booked for meetings for the specified day).

Time coin repository 102 and a number of time coins in time coin repository 102 may be viewed retroactively or prospectively. For example, a user may specify a span of time in the past that the user would like to view time coin allocation for, and the number of coins in the time coin repository 102 for that specified time would correspond to the number of time coins available to the organization during that specified timespan minus the number of time coins that were actually spent on tracked work tasks during that specified timespan. In some examples, a plurality of work tasks may be tracked and corresponding time coins withdrawn from time coin repository 102. That is, a plurality of tasks such as word processing tasks, spreadsheet tasks, presentation tasks, email tasks, and phone tasks may be tracked for each employee and corresponding time coins may be withdrawn from time coin repository 102 for each of those tracked tasks in addition to tracked meeting tasks. In other examples, only meeting tasks may be tracked and corresponding time coins withdrawn from time coin repository 102.

In some examples, a user may specify a span of time in the future that the user would like to view time coin allocation for, and the number of coins in the time coin repository 102 for that specified timespan would correspond to the number of time coins prospectively calculated to be available to the organization during that specified timespan (the number is tentative because additional time coins may in reality be added or subtracted due to employees leaving the organization, joining the organization, and/or employees working more or less hours than currently scheduled) minus the number of time coins that are currently scheduled to be spent during that specified timespan (i.e., the number of employee work time units that are currently scheduled for specific tracked tasks during that specified timespan).

In generating the time allocation for a timespan in the future, a time coin application may analyze an amount of employee work time that is currently booked up as meeting time for the specified timespan in the future that a user would like to view time allocation for. In other examples, the time coin application may analyze an amount of employee work time that is currently booked up as meeting time, as well as estimating an amount of time that may be spent on one or more additional work tasks for the specified timespan in the future that a user would like to view time allocation for. For example, a time coin application may track time spent on various other tasks (e.g., word processing tasks, spreadsheet tasks, email tasks, phone tasks) for employees over time, and calculate an estimated amount of time for a specified timespan that those tasks are likely to require from employees of an organization.

Blockchain sub-environment 112 includes a blockchain comprised of linked blocks, with each block of the blockchain corresponding to a scheduling event of a work task. In the illustrated example, the blockchain includes temporally consecutive blocks corresponding to a single work task (i.e., a meeting), with first block 116 corresponding to an initial “book meeting” task for the meeting, second block 118 corresponding to a “cancel meeting” task for the meeting, third block 120 corresponding to a “re-book meeting” task for the meeting, and fourth block 122 corresponding to an “expand meeting” task for the meeting. Blockchain sub-environment 112 also includes distributed nodes 114, which comprise a distributed task transaction ledger with identical copies of the ledger spread across a plurality of computing devices.

Each of the blocks in blockchain sub-environment 112 (i.e., blocks 116-122) each represent a withdrawal of one or more time coins from time coin repository 102 or a deposit of time coins back into time coin repository 102. Specifically, first block 116 represents a withdrawal of time coins from time coin repository 102, second block 118 represents a deposit of those time coins back into time coin repository 102, third block 120 represents a withdrawal of time coins from time coin repository 120 (which may be the same number or a different number of time coins as represented by first block 116 depending on whether more or less employees are invited to the re-booked meeting and/or whether the re-booked meeting is for the same amount of time or more or less time than the meeting represented by first block 116), and fourth block 122 represents an additional withdrawal of time coins from time coin repository 102 (e.g., the duration of the meeting represented by third block 120 has been lengthened).

In some examples, a single blockchain stored on a plurality of distributed ledgers on nodes 114 may include all of the time coin transactions for an organization, a group in an organization, a sub-group in an organization, and/or a single employee in an organization. In other examples, a plurality of blockchains stored on a plurality of distributed ledgers on nodes 114 may represent all of the time coin transactions for an organization, a group in an organization, a sub-group in an organization, and/or a single employee in an organization.

Computing device 124 displays a visual representation of time coin allocation for a specified duration of time. That is, a user may specify to a time coin application, that the user would like to view a visual representation of time coin allocation for a specific duration of time in the past or in the future, and the time coin application may cause the graph representing the time coin allocation for that specific duration of time to be displayed on computing device 124 as illustrated by the graph displayed on computing device 124. The user that generates a request for a visual representation of time coin allocation may specify a display type (e.g., graph, graph type, chart, chart type, spreadsheet data type, raw data type) that the user would like data corresponding to the specified duration of time to be visually displayed in, or the time coin allocation application may automatically select a display type for the data to be visually displayed in. In examples where the time coin application automatically selects a display type for the data, the time coin application may make a determination as to what display type to present the data in based on machine learning (e.g., past user data specific to a requesting user, past user data derived from third-party users), a type of chart that is most suitable for presentation of the type of data and/or the format of the data, custom user settings, and/or default application settings.

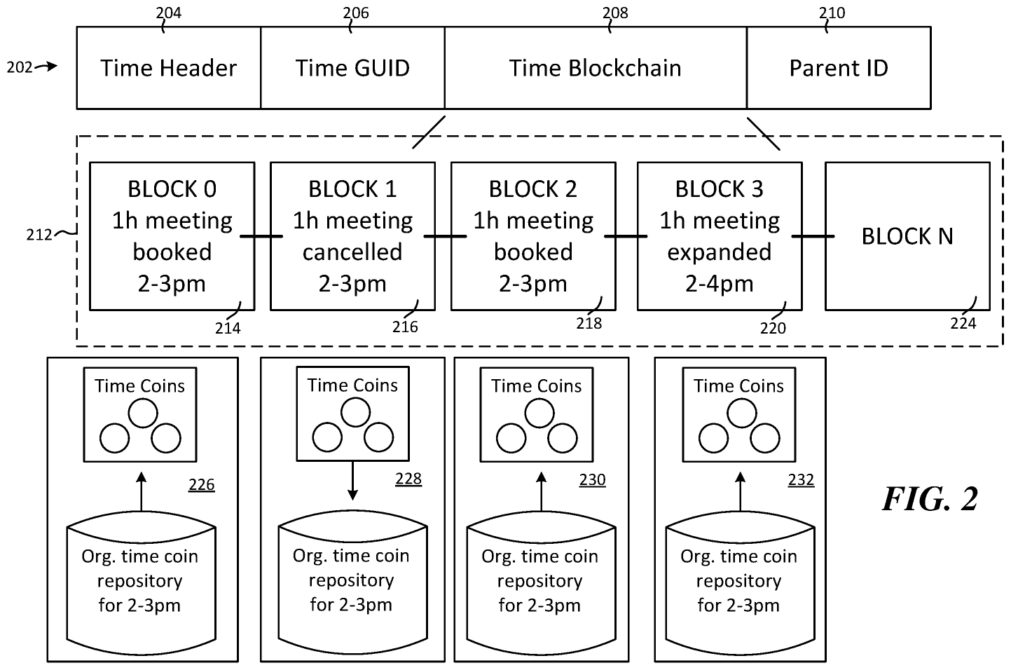

FIG. 2 illustrates an exemplary temporal blockchain 212 of transactions for a meeting event, individual components 202 of an exemplary block in the temporal blockchain, and the interplay of an organization time coin repository with each illustrated exemplary block. Blockchain 212 illustrates a chain of blocks corresponding to the scheduling of a meeting. A time coin application associated with a plurality of devices, each of which contains a distributed event ledger, may track each event transaction associated with the meeting, and create consecutive blocks in a blockchain corresponding to each one of those events.

For example, when a first user utilizes an electronic scheduling/meeting application and books a one-hour meeting between that user and one other person from 2-3 pm on day X in the future, a signal may be sent to each node containing a copy of the event ledger for a group associated with the first user, and a root block may be added to each node/ledger corresponding to the meeting event. In this example, the root block for the meeting event is “block 0” 214 in blockchain 212. The withdrawal of time coins from the time coin repository corresponding to the book meeting transaction of “block 0” 214 is illustrated by time coin withdrawal element 226.

Continuing with this example, the first user may utilize the meeting/scheduling application to cancel the meeting, and a block stemming from “block 0” 214 may be added to blockchain 212. In this example, the block corresponding to the cancel meeting transaction is “block 1” 216. The deposit of time coins back into the time coin repository corresponding to the cancel meeting transaction of “block 1” 228 is illustrated by time coin deposit element 228.

Still continuing with this example, the first user may again utilize the meeting/scheduling application to reschedule the meeting for the original time and duration (i.e., 2-3 pm on day X), and a block stemming from “block 1” 216 may be added to blockchain 212. In this example, the block corresponding to the reschedule meeting transaction is “block 2” 218. The withdrawal of time coins from the time coin repository corresponding to the reschedule meeting transaction of “block 2” 218 is illustrated by time coin withdrawal element 230.

Moving on with this example, the first user may determine that additional time is necessary for the meeting, and the first user may utilize the meeting/scheduling application to expand the meeting from 2-3 pm to 2-4 pm. In this example, the block corresponding to the meeting expansion transaction is “block 3” 220. The additional withdrawal of time coins from the time coin repository corresponding to the meeting expansion transaction of “block 3” 220 is illustrated by time coin withdrawal element 232.

Additional event transactions for this meeting may be added to the block chain, as is illustrated by “block N” 224. “Block N” 224 may correspond to any event transaction for the meeting, including book meeting transactions, reschedule meeting transactions, adding or removing parties to meeting transactions, cancel meetings transactions, expanding meeting duration transactions, shrinking meeting duration transactions, and the like. “Block N” 224 may also correspond to other tracked work activities, including document creation activities and email activities.

FIG. 2 also illustrates individual components 202 of an exemplary block in a temporal blockchain. In some examples, each of individual components 202 (i.e., time header 204, time GUID 206, time blockchain 208, and parent ID 210) may be included in each block of a temporal blockchain. In other examples, one or more of individual components 202 may not be included in one or more blocks of a temporal blockchain. In still other examples, additional components may be included in one or more blocks of a temporal blockchain.

In some examples, time header 204 includes a specific time and/or duration of time that an event is scheduled to take place or has already taken place (e.g., a date and/or time range that a meeting is scheduled for, a date and/or time range of a meeting that was scheduled but which has been canceled). In additional examples, time header 204 includes a specific time that an event transaction occurred (e.g., a time at which a user generated a book meeting request, a time at which a user generated a cancel meeting request). A time globally unique identifier (“GUID”) may also be included as a separate one of individual components 202, or as part of time header 204. A time GUID 206 in each block of a temporal blockchain allows users and/or the time coin application to lookup individual temporal events in a blockchain by a time that a corresponding event transaction occurred and/or by a start or end time corresponding to a timespan of a temporal event. Time blockchain 208 includes an indication of each transaction that came before it, as well as an indication of the type of transaction event that lead to generation of the corresponding block. Parent ID 210 includes an indication of the previous block in the temporal blockchain. In some examples, the indication may be a hash for the previous block in the blockchain.

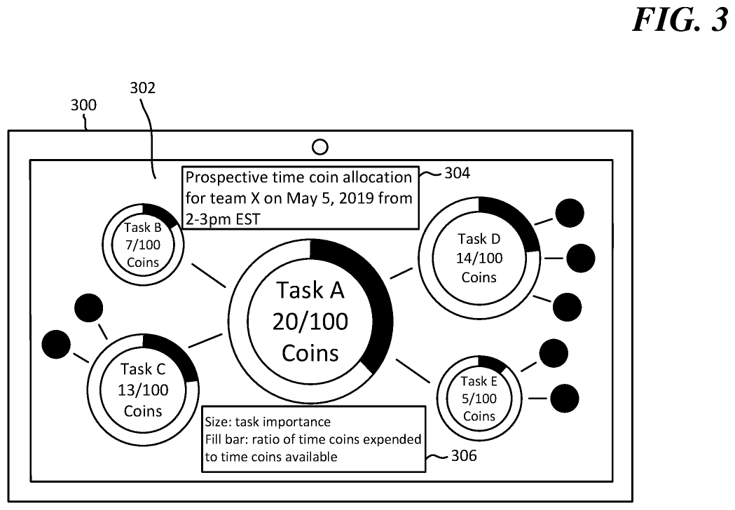

FIG. 3 illustrates an exemplary graph 302 that indicates work time cost to an organization for scheduling a meeting at a specified time, the graph 302 having been generated based on analysis of a temporal blockchain ledger. Graph 302 is one example of how the time coin application described herein may displayably convey a ratio of time coins that are currently expected to be expended for a specified duration of time in the future to time coins left in a time coin repository for an organization, group of an organization, and/or sub-group of an organization during that specified duration. The time coin application may also generate graphs and/or charts that convey a ratio of time coins that were expended for a specified duration of time in the past to time coins left in a time coin repository for an organization, group of an organization, and/or sub-group of an organization during that specified duration.

Graph 302 is presented on computing device 300, which a user may access a time coin application from. In some examples, the time coin application may be stored all or in part on computing device 300. In other examples, the time coin application may be cloud based and computing device 300 may access the time coin application remotely. Graph 302 includes a description 304 of the time coin information that is displayed on it (i.e., “Prospective time coin allocation for team X on May 5, 2019 from 2-3 pm EST”). Graph 302 also includes a key 306, which indicates that the size of the circular graph elements on graph 302 correspond to task importance, and that the fill bars for each of the circular graph elements on graph 302 correspond to a ratio of time coins expended to time coins available for the organizational group (i.e., team X) during the specified duration. The group that graph 302 corresponds to (i.e., team X) has been allocated 100 total time coins that may be spent by the specified one-hour duration between 2-3 pm on May 5, 2019. The 100 total time coins are illustrated as potentially be expendable/spent on five different tasks (i.e., Task A, Task B, Task C, Task D, and Task E). In some examples a time coin allocation graph may show time coin allocation for sub-tasks of primary tasks. For example, two sub-tasks are shown as contributing to task C, three sub-tasks are shown as contributing to task D, and two sub-tasks are shown as contributing to Task E. In some examples, a user navigating graph 302 may be able to zoom in on sub-tasks and the time coin application may cause more detailed information about sub-tasks to be displayed on graph 302. For example, a zoomed-in sub-task chart element may be caused to be displayed, which may show the number of time coins that are expected to be spent on the sub-task during a specified time period, and/or the importance of the subtask in relation to other sub-tasks and/or primary tasks.

Graph 302 includes a plurality of circular graph elements, each of which corresponds to a specific task that team X has assigned to it (e.g., organizational tasks). An exemplary total number of available time coins for team X for a specified duration of time (i.e., May 5, 2019 from 2-3 pm EST) is illustrated on the outer ring of each of the circular elements. Specifically, team X has 100 time coins available to it for the one hour duration from 2-3 pm EST on the specified day. The task that is indicated as most important by its corresponding circular chart element is task A. The chart element corresponding to task A indicates that task A currently has 20 out of 100 available coins for team X that are expected to be spent on task A during the specified duration on May 5. The chart element corresponding to task B indicates that task B currently has 7 out of 100 available coins for team X that are expected to be spent on task B during the specified duration on May 5. The chart element corresponding to task C indicates that task C currently has 13 out of 100 available coins for team X that are expected to be spent on task C during the specified duration on May 5. The chart element corresponding to task D indicates that task D currently has 14 out of 100 available coins for team X that are expected to be spent on task D during the specified duration on May 5, and the chart element corresponding to task E indicates that task E currently has 5 out of 100 available coins for team X that are expected to be spent on task E during the specified duration.

The number of time coins that are illustrated for each task as being expected to be spent during the specified duration may be determined based on: an amount of time that employees assigned to each task currently have scheduled meetings for that task during the specified duration, an estimate based on historical work patterns of an amount of time that employees assigned to each task are expected to spend performing other work duties (e.g., document creation, responding to emails, phone calls) during the specified duration, and/or an estimate based on historical work patterns of an amount of time that employees assigned to each task are expected to spend in meetings during the specified duration.

Other graph types, display elements, and graph objects for displaying time coin data are contemplated by the description herein. In some examples, a user may interact with the time coin application to identify a cheapest timeslot in the future to schedule a meeting for a group. In some examples the user may set a range of dates and/or times that the user would like to schedule the meeting during, and the time coin application may generate a graph that indicates the currently estimated time coin cost for a plurality of timeslots in the range. For example, if the individuals that are to attend the meeting are currently expected to expend 75 out of a total of 100 time coins for a first date in the range, and they are only expected to expend 25 out of a total of 100 coins for a second date in the range, the relative higher cost of the user booking the meeting during the first date in the range as opposed to less costly second date in the range can be graphically illustrated in a chart generated by the time coin application.

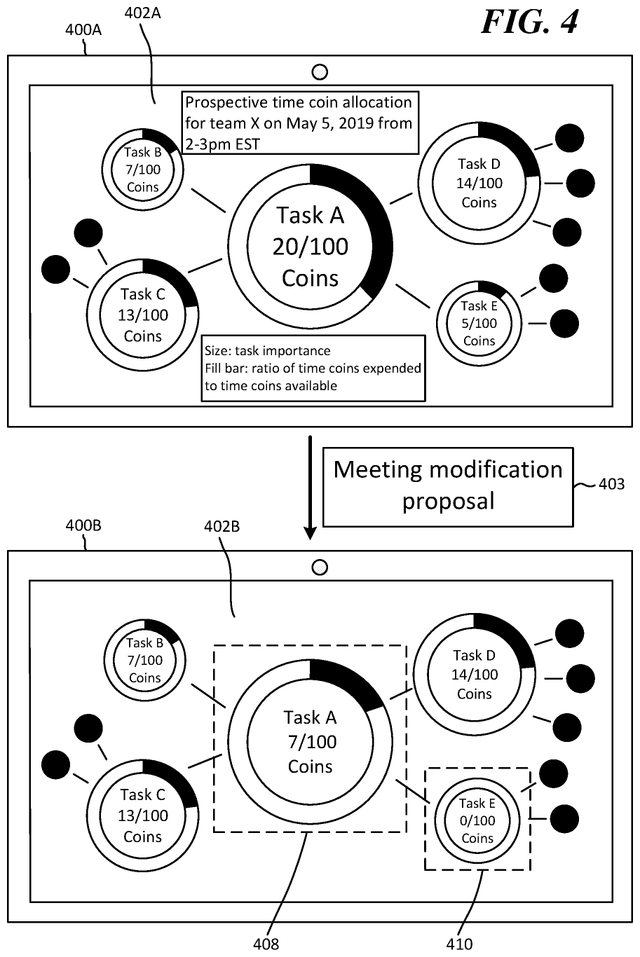

FIG. 4 illustrates a first exemplary graph 402A on a computing device 400A that indicates work time cost to an organization for scheduling a meeting at a first specified time, and the modification of that graph into a second graph 402B on computing device 400B, which may be the same computing device as computing device 400A, that indicates work time cost to the organization for scheduling the meeting at a second specified time, both graphs generated based on analysis of a temporal blockchain ledger. Graph 402A is the same graph that is illustrated in FIG. 3. Specifically, for a specified duration of one hour on May 5, 2019 from 2-3 pm, the time coin application has determined based on analysis of a distributed blockchain ledger that if a meeting is scheduled for that timeslot, team X will have an expected time coin allocation ratio of 20/100 coins for task A, 7/100 coins for task B, 13/100 coins for task C, 14/100 coins for task D, and 5/100 coins for task E. In some examples, the total number of time coins for team X reflected in first graph 402A and second graph 402B (i.e., 100 coins) may be a total number of time coins that team X has to spend on meeting and/or other work tasks during a day, span of days, week, month or other duration of time. However, for ease of illustration, it can be assumed that the total number of available time coins for team X in first graph 402A and second graph 402B are for the day of May 5, 2019.

A meeting modification proposal 403 has been input to the time coin application. For example, a user viewing first graph 402A may want to attempt to find a time for the meeting that will not affect one or more tasks as drastically as the currently proposed time that is the reflected in first graph 402A. In some examples, the user may input a different proposed meeting time to the time coin application, and second graph 402B may be generated, illustrating the modified time coin allocation based on that proposed modification. In this case, the modification has resulted in a decrease in time coins allocated to task A and task E, with user interface element 408 indicating that the modification will result in the time coin allocation for task A changing from 20/100 coins to 7/100 coins, and user interface element 410 indicating that the modification will result in the time coin allocation for task E changing from 5/100 coins to 0/100 coins. Because less time coins are expected to be spent on task A and task E based on the proposed meeting time modification, the user may wish to book the meeting for the time corresponding to first graph 402A rather that for the modified time corresponding to second graph 402B.

In additional examples, the user may input a duration of dates/times that the user would like to schedule the meeting, as well as one or more of the tasks that the user does not want time coin spend to be adversely taken away from based on the scheduling of the meeting, and the time coin application may automatically identify one or more dates/times that impact the time coin spend for those tasks the least. The time coin application may present the one or more dates/times graphically to the user with a projected time coin allocation for each task during the proposed one or more dates/times based on the meeting being scheduled during the proposed one or more dates/times.

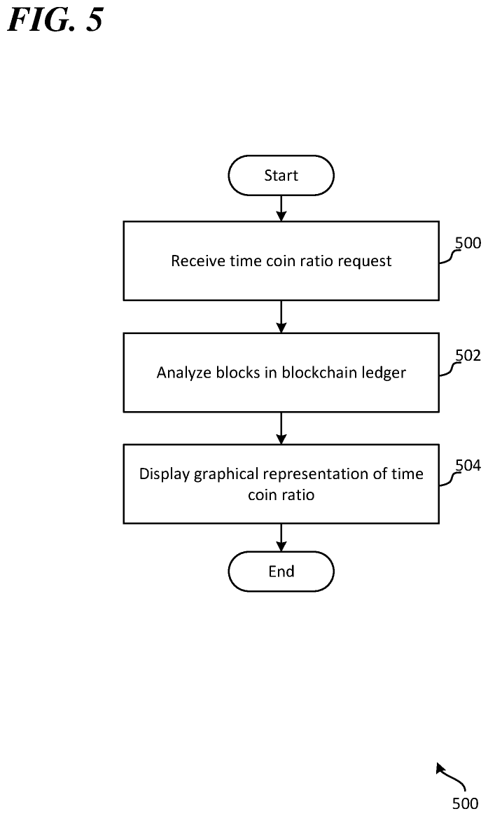

FIG. 5 is an exemplary method 500 for indicating time-cost allocation for an organization for a specified time period. The method 500 begins at a start operation and flow continues to operation 502 where a request is received to display a graphical representation of a ratio of time coins to be withdrawn from a time repository for an organization for each of a plurality of tasks during a specified time period compared with a number of total coins remaining in the time repository for the organization during the specified time period. The request may be received by a time coin application that a user accesses directly from their personal computing device and/or that is accessed remotely as a cloud-based application. The requesting user may specify a timespan that the user would like to see a time coin allocation ratio for, and the specified timespan may be retrospective or prospective. That is, the user may request to see a time coin allocation ratio for some time in the past or for some time in the future. The user may also specify an organizational group or organizational individual that the user would like to see the time coin allocation for. In additional examples, the request may be generated based on a user requesting to view one or more cheapest (from a time coin perspective) timeslots to schedule a meeting of a specified duration of time during a specified timespan.

From operation 502 flow continues to operation 504 where a plurality of blocks in a blockchain ledger are analyzed. Each of the plurality of blocks may indicate one of: at least one time coin that is to be withdrawn from the time repository for the organization and applied to one of the plurality of tasks; and at least one time coin that is to be deposited back into the time repository for the organization. Each analyzed block in the blockchain corresponds to one or more individuals of the organization. For example, if the received request is a request to have a graph of five work days displayed along with time coin allocation for each of those five work days for three potential members of a meeting, each analyzed block in the blockchain would correspond to a temporal transaction affecting one or more of the three potential members.

From operation 504 flow continues to operation 506 where the graphical representation of the ratio of time coins is caused to be displayed based on the analysis of the plurality of blocks in the blockchain ledger. In some examples, the graphical representation may provide a prospective indication of the ratio of time coins that are currently expected to be spent by an organization, group of an organization, sub-group of an organization and/or an individual of an organization for a specified duration, in relation to a total number of coins for the specified duration for the corresponding organization, group of the organization, sub-group of the organization and/or individual of the organization. In other examples, the graphical representation may provide a prospective indication, based on one or more proposed meeting times, of a ratio of time coins that are currently expected to be spent by an organization, group of an organization, sub-group of an organization and/or an individual of an organization for a specified duration, in addition to a number of time coins to be spent for the proposed meeting, in relation to a total number of coins for the specified duration.

From operation 506 flow continues to an end operation and the method 500 ends.

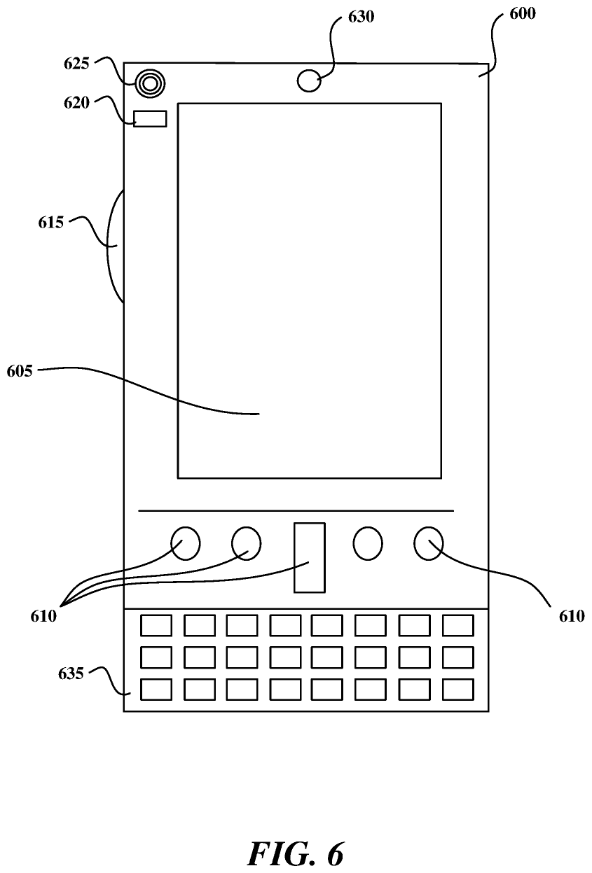

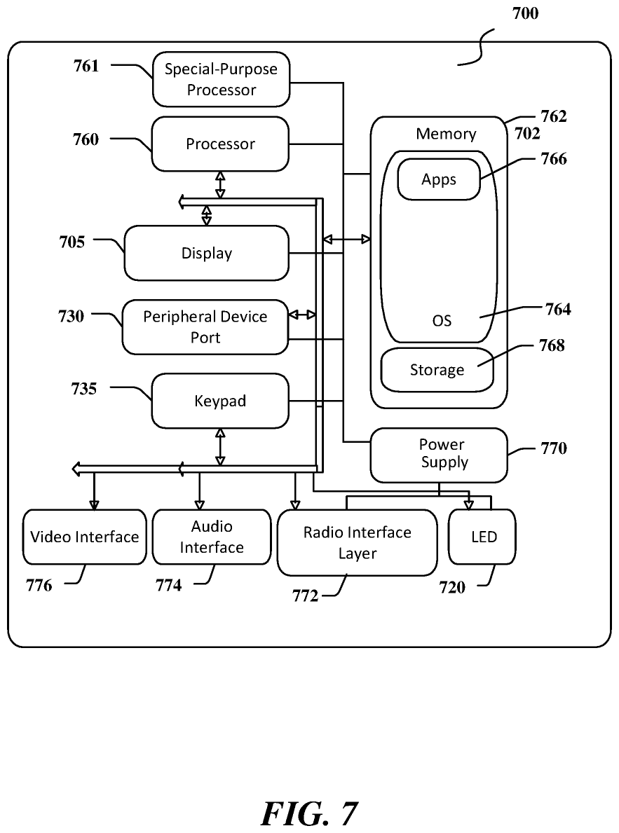

FIGS. 6 and 7 illustrate a mobile computing device 600, for example, a mobile telephone, a smart phone, wearable computer (such as smart eyeglasses), a tablet computer, an e-reader, a laptop computer, or other AR compatible computing device, with which embodiments of the disclosure may be practiced. With reference to FIG. 6, one aspect of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative aspects, mobile computing device 600 may incorporate more or fewer input elements. For example, the display 605 may not be a touch screen in some embodiments. In yet another alternative embodiment, the mobile computing device 600 is a portable phone system, such as a cellular phone. The mobile computing device 600 may also include an optional keypad 635. Optional keypad 635 may be a physical keypad or a “soft” keypad generated on the touch screen display. In various embodiments, the output elements include the display 605 for showing a graphical user interface (GUI), a visual indicator 620 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 7 is a block diagram illustrating the architecture of one aspect of a mobile computing device. That is, the mobile computing device 700 can incorporate a system (e.g., an architecture) 702 to implement some aspects. In one embodiment, the system 702 is implemented as a “smart phone” capable of running one or more applications (e.g., browser, e-mail, calendaring, contact managers, messaging clients, games, and media clients/players). In some aspects, the system 702 is integrated as a computing device, such as an integrated personal digital assistant (PDA) and wireless phone.

One or more application programs 766 may be loaded into the memory 762 and run on or in association with the operating system 864. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700, including instructions for providing and operating a time coin temporal transaction computing platform.

The system 702 has a power supply 770, which may be implemented as one or more batteries. The power supply 770 might further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 620 may be used to provide visual notifications, and/or an audio interface 774 may be used for producing audible notifications via the audio transducer 625. In the illustrated embodiment, the visual indicator 620 is a light emitting diode (LED) and the audio transducer 625 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 625, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 702 may further include a video interface 776 that enables an operation of an on-board camera 630 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7 by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio interface layer 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 772 or via a distributed computing network. Similarly, such data/information may be readily transferred between computing devices for storage and use according to well-known data/information transfer and storage means, including electronic mail and collaborative data/information sharing systems.

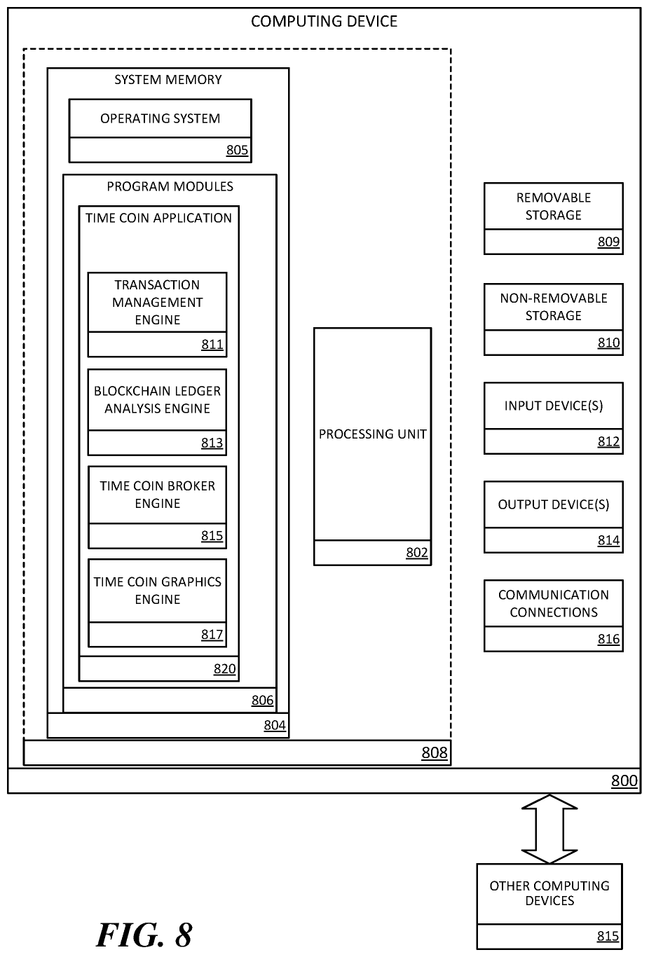

FIG. 8 is a block diagram illustrating physical components (e.g., hardware) of a computing device 800 with which aspects of the disclosure may be practiced. The computing device components described below may have computer executable instructions for assisting with execution of verbal digital assistant commands in a group device environment. In a basic configuration, the computing device 800 may include at least one processing unit 802 and a system memory 804. Depending on the configuration and type of computing device, the system memory 804 may comprise, but is not limited to, volatile storage (e.g., random access memory), non-volatile storage (e.g., read-only memory), flash memory, or any combination of such memories. The system memory 804 may include an operating system 805 suitable for running one or more digital assistant programs. The operating system 805, for example, may be suitable for controlling the operation of the computing device 800. Furthermore, embodiments of the disclosure may be practiced in conjunction with a graphics library, other operating systems, or any other application program and is not limited to any particular application or system. This basic configuration is illustrated in FIG. 8 by those components within a dashed line 808. The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage device 809 and a non-removable storage device 810.

As stated above, a number of program modules and data files may be stored in the system memory 804. While executing on the processing unit 802, the program modules 806 (e.g., time coin application 820) may perform processes including, but not limited to, the aspects, as described herein. According to examples, transaction management engine 811 may perform one or more operations associated with monitoring temporal transactions (e.g., meeting events, document creation activities, email activities) of organizational entities, and generating temporal blockchain blocks based on those transactions. Blockchain ledger analysis engine 813 may perform one or more operations associated with analyzing blocks in a temporal blockchain ledger to determine the authenticity of temporal events described therein, and determining time allocation ratios for specified durations. Time coin broker engine 815 may perform one or more operations associated with analyzing temporal transactions may by organizational entities and withdrawing and/or depositing a corresponding number of time coins from a time coin repository. Time coin analytics engine may perform one or more operations associated with generating one or more graphs, charts, documents, and/or objects reflecting the results of an analysis performed on a temporal blockchain for determining a time allocation ratio for one or more specified durations.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 800 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 800 may also have one or more input device(s) 812 such as a keyboard, a mouse, a pen, a sound or voice input device, a touch or swipe input device, etc. The output device(s) 814 such as a display, speakers, a printer, etc. may also be included. The aforementioned devices are examples and others may be used. The computing device 800 may include one or more communication connections 816 allowing communications with other computing devices 850. Examples of suitable communication connections 816 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 804, the removable storage device 809, and the non-removable storage device 810 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer storage media may be part of the computing device 800. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

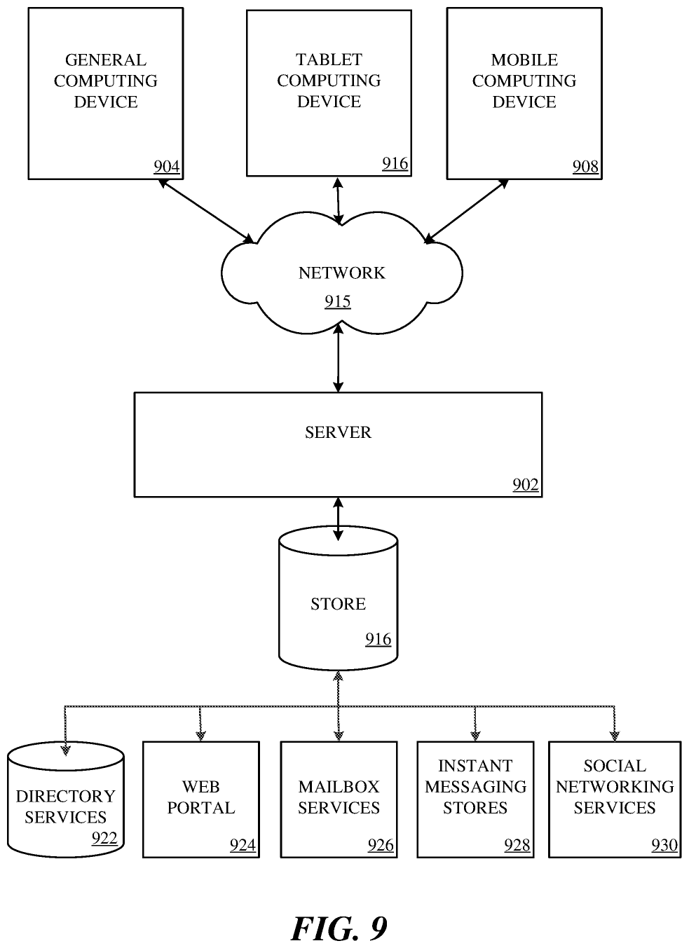

FIG. 9 illustrates one aspect of the architecture of a system for processing data received at a computing system from a remote source, such as a personal/general computer 904, tablet computing device 906, or mobile computing device 908, as described above. Content displayed at server device 902 may be stored in different communication channels or other storage types. For example, various documents may be stored using a directory service 922, a web portal 924, a mailbox service 926, an instant messaging store 928, or a social networking site 930. The program modules 806 may be employed by a client that communicates with server device 902, and/or the program modules 806 may be employed by server device 902. The server device 902 may provide data to and from a client computing device such as a personal/general computer 904, a tablet computing device 906 and/or a mobile computing device 908 (e.g., a smart phone) through a network 915. By way of example, the computer system described above with respect to FIGS. 6-8 may be embodied in a personal/general computer 904, a tablet computing device 906 and/or a mobile computing device 908 (e.g., a smart phone). Any of these embodiments of the computing devices may obtain content from the store 916, in addition to receiving graphical data useable to be either pre-processed at a graphic-originating system, or post-processed at a receiving computing system.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The systems, methods, and devices described herein provide technical advantages for efficiently identifying time blocks that are most advantageous for scheduling new meetings, while maintaining the integrity of work time transaction history via a distributed temporal transaction ledger. By utilizing a time coin application as described herein, users can obtain graphical summaries of where work time in an organization is expected to be taken up in the future for meeting scheduling purposes, and where work time in an organization was spent in the past, which is useful for identifying patterns and training machine learning models for projecting the distribution of future work time in the organization. By enhancing projected work time models through the use of trained machine learning models as described, a more accurate estimate can be made as to what proposed meeting timespans are likely to be least costly to an organization. User time and processing costs to schedule meetings are also reduced utilizing the systems, methods and devices described herein by allowing a time coin application to efficiently identify the least costly times to schedule meetings, thereby reducing the number of electronic messages required to scheduling of meetings. Organizational productivity can also be maximized through the mechanisms described herein by allowing organizational managers to view time allocation summaries in the form of time coin ratio graphics, which can be utilized by the managers to manage the use of company time more efficiently. The distributed temporal transaction ledger allows organizations to ensure that the time that employees spent working on tasks was not modified to reflect task work that did not actually happen. By ensuring that the record of employee work time is not tampered with, organizations can save time and resources, including computer processing resources, analyzing past work time.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present disclosure, one skilled in the art may envision variations, modifications, and alternate aspects falling within the spirit of the broader aspects of the general inventive concept embodied in this application that do not depart from the broader scope of the claimed disclosure.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A system for indicating time-cost allocation for an organization for a specified time period, comprising:
a memory for storing executable program code; and
one or more processors, functionally coupled to the memory, the one or more processors being responsive to computer-executable instructions contained in the program code and operative to:
receiving a request to display a graphical representation of a ratio of time coins to be withdrawn from a time repository for the organization for each of a plurality of tasks during the specified time period compared with a number of total time coins remaining in the time repository for the organization during the specified time period;
analyzing a plurality of blocks in a blockchain ledger, wherein each of the plurality of blocks indicates one of: at least one time coin that is to be withdrawn from the time repository for the organization and applied to one of the plurality of tasks; and at least one time coin that is to be deposited back into the time repository for the organization; and
displaying, based on the analysis, the graphical representation.

2. The system of claim 1, wherein the time repository comprises a plurality of time coins corresponding to a plurality of work units of time that are expendable by the organization.

3. The system of claim 1, wherein the plurality of tasks comprise: a meeting task, an email task, and a document editing task.

4. The system of claim 1, wherein the one or more processors are further responsive to the computer-executable instructions contained in the program code and operative to:
assign a cost of withdrawal to each time coin in the time repository for the specified time period, wherein the cost of withdrawal for each time coin increases relative to a percentage of time coins in the time repository decreasing; and
display, in the graphical representation, the cost of withdrawal for each time coin in the time repository for the specified time period.

5. The system of claim 1, wherein the displayed graphical representation further comprises a display element indicating an importance of each one of the plurality of tasks compared with each other one of the plurality of tasks.

6. The system of claim 1, wherein the one or more processors are further responsive to the computer-executable instructions contained in the program code and operative to:
receive an indication to modify the displayed graphical representation based on a proposed reallocation of a plurality of time coins during the specified time period;
modify the blockchain based on the proposed reallocation of the plurality of time coins; and
modify the displayed graphical representation based on the modified blockchain.

7. The system of claim 6, wherein the received indication to modify the displayed graphical representation comprises a request to book a meeting for a time period corresponding to the specified time period.

8. A computer-readable storage device comprising executable instructions that, when executed by one or more processors, assists with indicating time-cost allocation for an organization for a specified time period, the computer-readable storage device including instructions executable by the one or more processors for:
receiving a request to display a graphical representation of a ratio of a value of time coins to be withdrawn from a time repository for the organization for each of a plurality of tasks during the specified time period compared with a value of time coins remaining in the time repository for the organization during the specified time period;
analyzing a plurality of blocks in a blockchain ledger, wherein each of the plurality of blocks indicates one of: at least one time coin that is to be withdrawn from the time repository for the organization and applied to one of the plurality of tasks; and at least one time coin that is to be deposited back into the time repository for the organization; and
displaying, based on the analysis, the graphical representation.

9. The computer-readable storage device of claim 8, wherein each time coin that is to be withdrawn from the time repository for the organization has a value associated with it corresponding to a hierarchical level of a member of the organization that it represents time value for.

10. The computer-readable storage device of claim 8, wherein the time repository comprises a plurality of time coins corresponding to a plurality of work units of time that are expendable by the organization.

11. The computer-readable storage device of claim 8, wherein the displayed graphical representation is a graph that indicates a value of time coins spent on each one of the plurality of tasks compared with each other one of the plurality of tasks.

12. The computer-readable storage device of claim 8, wherein the instructions are further executable by the one or more processors for:
receiving an indication to modify the displayed graphical representation based on a proposed reallocation of a plurality of time coins during the specified time period;
modify the blockchain based on the proposed reallocation of the plurality of time coins; and
modify the displayed graphical representation based on the modified blockchain.

13. The computer-readable storage device of claim 12, wherein the received indication to modify the displayed graphical representation comprises a request to book a meeting for a time period corresponding to the specified time period.

14. A method for displaying a time-cost allocation summary for each of a plurality of members of an organization for a designated time period, the method comprising:
receiving a request to display the time-cost allocation summary, wherein the time-cost allocation summary comprises a graphical representation of a ratio of time units to be withdrawn from a time repository for the organization by each of the plurality of members during the designated time period for each of a plurality of tasks compared with a number of total time units remaining in the time repository for the organization during the designated time period;
analyzing a plurality of blocks in a blockchain ledger, wherein each of the plurality of blocks indicates one of: at least one unit of time that is to be withdrawn from the time repository for the organization and applied to one of the plurality of tasks; and at least one unit of time that is to be deposited back into the time repository for the organization; and
displaying, based on the analysis, the time-cost allocation summary for each of the plurality of members.

15. The method of claim 14, wherein each of the plurality of members comprises a plurality of individuals associated with a group of the organization.

16. The method of claim 14, wherein each of the plurality of members comprises a single employee of the organization.

17. The method of claim 14, wherein the plurality of tasks comprise: a meeting task, an email task, and a document editing task.

18. The method of claim 14, wherein each of the plurality of tasks comprises a project that one or more members of the organization have been assigned to complete.

19. The method of claim 14, wherein the time-cost allocation summary is a heat map.

20. The method of claim 14, wherein the time-cost allocation summary further comprises a display element indicating an importance of each one of the plurality of tasks compared with each other one of the plurality of tasks.
